(19) United States
(12) Patent Application Publication
(10) Pub. No.: US 2025/0236218 A1
(43) Pub. Date: Jul. 24, 2025

(54) VEHICLE SEAT

(71) Applicant: Honda Motor Co., Ltd., Tokyo (JP)

(72) Inventors: Shogo USUI, Tokyo (JP); Koji HASHIMOTO, Tokyo (JP); Masakazu OKADA, Tokyo (JP)

(73) Assignee: Honda Motor Co., Ltd., Tokyo (JP)

(21) Appl. No.: 18/961,457

(22) Filed: Nov. 27, 2024

(30) Foreign Application Priority Data
Jan. 23, 2024 (CN) 202410093632.0

(51) Int. Cl. B60N 2/02; G06T 7/70

(52) U.S. Cl. CPC B60N 2/0278; B60N 2/02246; G06T 7/70; G06T 2207/30268

(57) ABSTRACT

A vehicle seat includes an electric device for moving at least one of a seat cushion and a seat back. The vehicle seat includes an in-vehicle capturing device and a processing device. The in-vehicle capturing device is configured to capture interior image including at least one of the seat cushion and the seat back. The processing device is configured to compare the interior image with an interior specified image when the at least one of the seat cushion and the seat back is in a specified position, to calculate an absolute position of the at least one of the seat cushion and the seat back from an amount of change of the at least one of the seat cushion and the seat back relative to the specified position.

### CROSS-REFERENCE TO RELATED APPLICATION

This application claims the priority benefit of China application serial no. 202410093632.0, filed on Jan. 23, 2024. The entirety of the above-mentioned patent application is hereby incorporated by reference herein and made a part of this specification.

### BACKGROUND

### Technical Field

The disclosure relates to a seat, and in particular relates to a vehicle seat.

### Description of Related Art

In recent years, efforts have been actively made to provide access to sustainable transportation systems for those in vulnerable positions, such as the elderly or children. In order to achieve the above-mentioned purpose, research and development are devoted to further improving the safety and convenience of traffic through developments related to the vehicle seats.

Like electric windows and sunroofs, vehicle seats use motor pulse sensors to detect their position. For electric windows and sunroofs, absolute positions can be detected, but for vehicle seats, currently only relative positions can be detected rather than absolute positions.

FIG. 1A is a schematic diagram of conventional window position detection, and FIG. 1B is a schematic diagram of conventional seat position detection. Referring to FIG. 1A first, in the conventional method for detecting window position, the fully closed position of the operable window 12 is used as a reference point for convenience. The absolute position of electric windows, sunroofs, and similar components can be determined through the increase or decrease in pulse count as measured by the motor pulse sensor of the window 12. Referring to FIG. 1B, when trying to detect the absolute position of the seat 14, it is necessary to move the seat 14 to the front edge, rear edge, top edge, or bottom edge in order to determine the position of the seat 14 through the increase or decrease in pulse count from the motor pulse sensor of the seat 14. However, for the convenience of use, the frequency of this operation is very low. Due to the necessity of moving the seat 14 for manufacturing and service purposes, there exists a problem in readily detecting the absolute position of the seat 14.

In addition, due to motor clearance and motor sensor hysteresis, positional deviation invariably occurs. This positional deviation tends to accumulate and increase over time. Consequently, periodic relearning is necessary. However, the appropriate trigger mechanism for initiating such relearning remains undetermined. In addition, based on different trigger conditions, customers may inadvertently start moving the seat suddenly, resulting in being trapped in the seat, or incorrect learning may occur due to overloading in the process.

Patent Document 1 (Japanese Laid Open Patent Publication No. 05-208630) discloses that “when the electric seat control unit is activated (power-on reset), the central processing unit (CPU) uses the posture of the seat at that time as the origin.” This only teaches to obtain the seat position through relative positions rather than absolute positions.

### SUMMARY

A vehicle seat is provided in the disclosure, the vehicle seat includes an electric device for moving at least one of a seat cushion and a seat back. The vehicle seat includes an in-vehicle capturing device and a processing device. The in-vehicle capturing device is configured to capture interior image including at least one of the seat cushion and the seat back. The processing device is configured to compare the interior image with an interior specified image when the at least one of the seat cushion and the seat back is in a specified position, to calculate an absolute position of the at least one of the seat cushion and the seat back from an amount of change of the at least one of the seat cushion and the seat back relative to the specified position.

In order to make the aforementioned and other features and advantages of the disclosure comprehensible, embodiments accompanied with drawings are described in detail below.

### BRIEF DESCRIPTION OF THE DRAWINGS

FIG. 1A is a schematic diagram of conventional window position detection.

FIG. 1B is a schematic diagram of conventional seat position detection.

FIG. 2 is a block diagram of a vehicle seat according to an embodiment of the disclosure.

FIG. 3 is a layout diagram of a vehicle seat according to an embodiment of the disclosure.

FIG. 4 is a flowchart of a vehicle seat position calculation method according to an embodiment of the disclosure.

FIG. 5A to FIG. 5E are examples of calculating a vehicle seat position according to an embodiment of the disclosure.

FIG. 6 is an example of calculating a vehicle seat position according to an embodiment of the disclosure.

FIG. 7 is a flowchart of a vehicle seat position calculation method according to an embodiment of the disclosure.

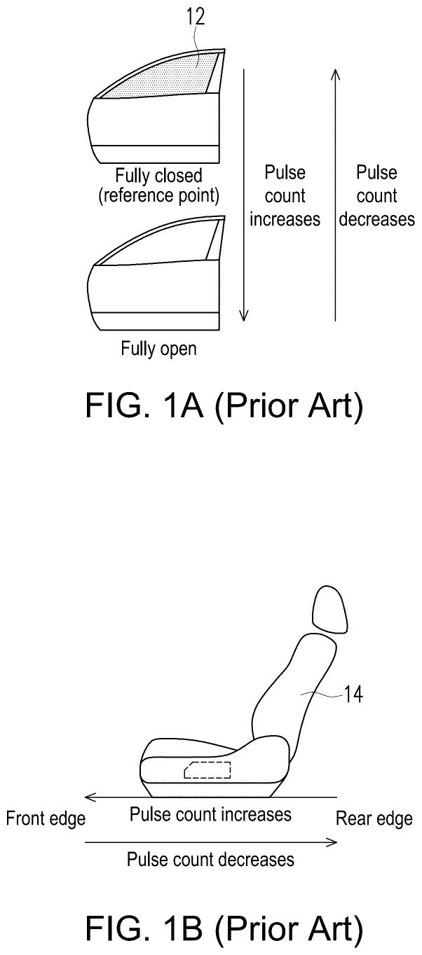

### DETAILED DESCRIPTION OF DISCLOSED EMBODIMENTS

Hereinafter, embodiments of the disclosure are described with reference to the drawings.

For vehicle seats, current technology cannot prevent the position from changing over time, so knowing the absolute position of the vehicle seat is an issue.

In order to solve the above-mentioned issue, this disclosure aims to obtain the absolute position of the vehicle seat. Moreover, it further contributes to the development of sustainable transportation systems.

In the vehicle seat according to an embodiment of the disclosure, the processing device also compares the interior image with a vehicle body portion included in the interior specified image.

The disclosure realizes the detection of the absolute position of the seat by using an in-vehicle capturing device, which can address the issue encountered when there is a need to move the seat to the front or rear end for manufacturing and service purposes.

Based on the anticipation that in-vehicle devices such as cameras, which can serve as dash cams and prevent infants from being left in vehicles, are expected to become standard equipment in the future, the embodiment of the disclosure utilizes sensing devices such as cameras or millimeter wave radar configured within the vehicle to examine images of the sliding, reclining, tilting, height or the seat, headrest, cushion, lumbar support, and thigh support when there is no occupant in the driver's seat. These images are then compared with pre-stored image data and position data to detect the absolute position of each aforementioned component. The embodiment of the disclosure also examines changes in images and position comparison results, removes images and data that vary greatly, and determines the position by calculating the average of multiple detection results, thereby improving the accuracy of the detected position.

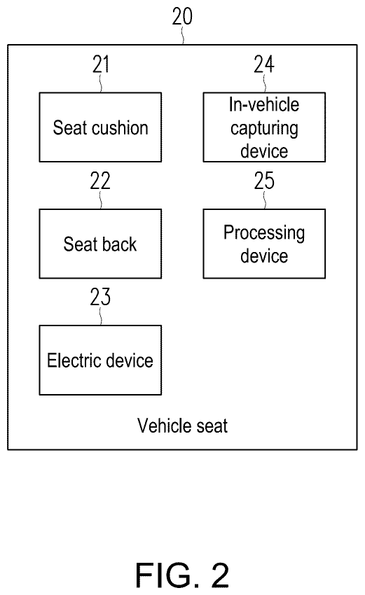

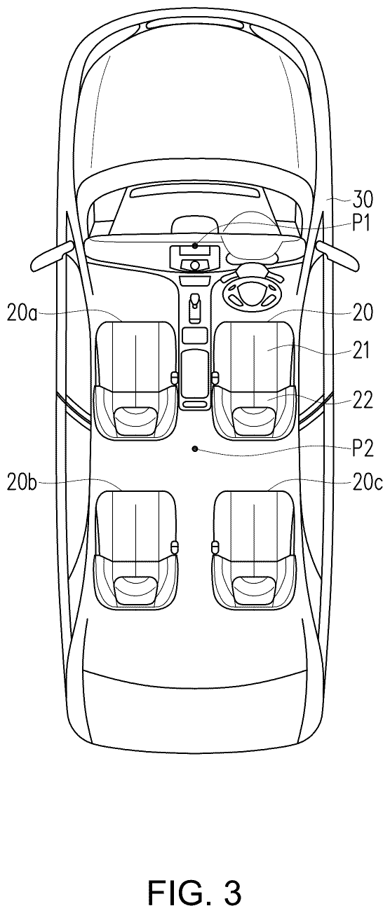

FIG. 2 is a block diagram of a vehicle seat according to an embodiment of the disclosure. FIG. 3 is a layout diagram of a vehicle seat according to an embodiment of the disclosure. Referring to FIG. 2 and FIG. 3 at the same time, the vehicle seat 20 of this embodiment is, for example, installed or configured at the driver's seat position in the vehicle 30 to detect its own position. In this embodiment, the vehicle 30 is, for example, a car using an internal combustion engine such as a diesel engine or a gasoline engine as a power source, an electric car using an electric motor as a power source, or a hybrid car having both an internal combustion engine and an electric motor. In some embodiments, the vehicle seat 20 can also be configured to detect the position of one or more other vehicle seats (e.g., vehicle seats 20a, 20b, 20c) in the vehicle 30, which is not limited thereto.

The vehicle seat 20 includes a seat cushion 21, a seat back 22, and an electric device 23 such as a motor for moving the seat cushion 21 and/or the seat back 22, and includes an in-vehicle capturing device 24 and a processing device 25 disposed in the vehicle 30.

The in-vehicle capturing device 24 is, for example, a millimeter wave radar, light detection and ranging (LiDAR), sonar, ultrasonic, infrared and other sensors, or cameras or video cameras that include a charge coupled device (CCD), a complementary metal-oxide semiconductor (CMOS) device, or other types of photosensitive devices, which is not limited thereto. The in-vehicle capturing device 24 is, for example, disposed on the dashboard, center console, rear view mirror, interior light, roof, etc., of the vehicle 30, such the roof position P1 above the center console or the rear interior light position P2 shown in FIG. 3, to capture interior images including at least one of the seat cushion 21 and the seat back 22.

The processing device 25, for example, may be implemented through the execution of programs by processors such as an electronic control unit (ECU) or a central processing unit (CPU), or through hardware such as large scale integration (LSI), application specific integrated circuit (ASIC), or field programmable gate array (FPGA). Furthermore, it may be implemented through a combination of software and hardware. This embodiment does not limit its implementation.

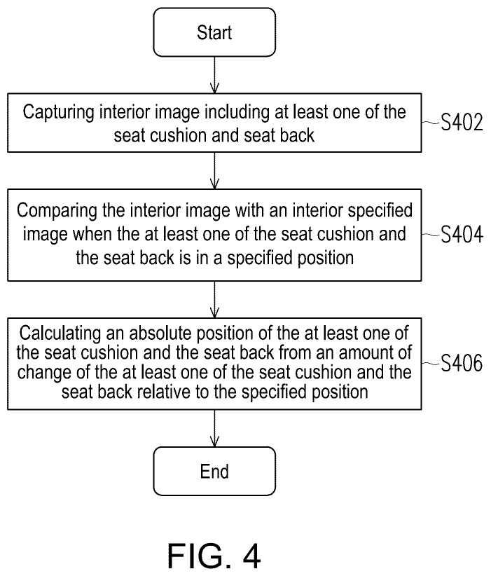

FIG. 4 is a flowchart of a vehicle seat position calculation method according to an embodiment of the disclosure. Referring to FIG. 2 and FIG. 4 at the same time, the vehicle seat position calculation method of this embodiment is applicable to the vehicle seat 20 of FIG. 2. Detailed steps of the vehicle seat position calculation method of this embodiment is described below with reference to each component in the vehicle seat 20.

In step S402, the processing device 25 controls the in-vehicle capturing device 24 to capture an interior image including at least one of the seat cushion 21 and the seat back 22. The processing device 25, for example, sends a request to the in-vehicle capturing device 24 to capture interior images during the ignition-off state (IG-OFF), at the time of intelligent keyless locking, but this embodiment is not limited thereto.

In step S404, the processing device 25 compares the captured interior image with an interior specified image when at least one of the seat cushion 21 and the seat back 22 is in a specified position. For example, if the image captured by the in-vehicle capturing device 24 is an image of the seat cushion 21, the processing device 25 compares the image with the interior specified image when the seat cushion 21 is in the specified position. If the image captured by the in-vehicle capturing device 24 is an image of the seat back 22, the processing device 25 compares the image with the interior specified image when the seat back 22 is in the specified position. If the image captured by the in-vehicle capturing device 24 is an image including the seat cushion 21 and the seat back 22, the processing device 25 compares the image with the interior specified image when the seat cushion 21 and the seat back 22 are in the specified position. The specified positions include the front edge, rear edge, top edge, bottom edge or any position within the movable range of the seat cushion 21, and the forward tilt, rearward tilt or any angle within the tilt range of the seat back 22, and are not limited thereto.

In step S406, the processing device 25 calculates the absolute position of the at least one of the seat cushion 21 and the seat back 22 from an amount of change of the at least one of the seat cushion 21 and the seat back 22 relative to the specified position. In some embodiments, changes in nominal data images may be considered, and changes in camera setting positions, seat fixed positions, etc. may be excluded. Specifically, based on the fact that the camera is installed at the same position on the vehicle, if the viewing angles are the same, the position of the seat can be determined based on the size of the seat in the image. In detail, by disposing a component of known size so that it is always within the viewing angle of the camera, the absolute position of the seat can be calculated according to the amount of change in the measured size of this component relative to the known size.

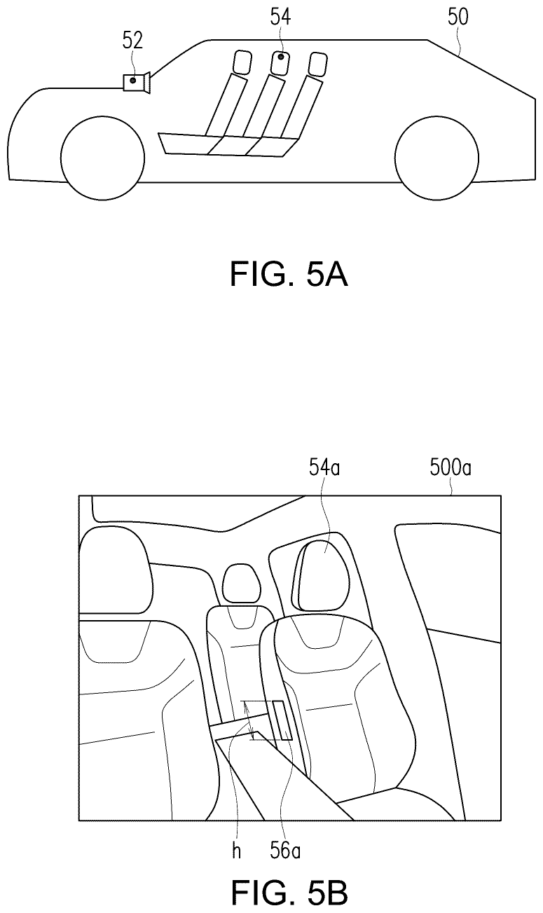

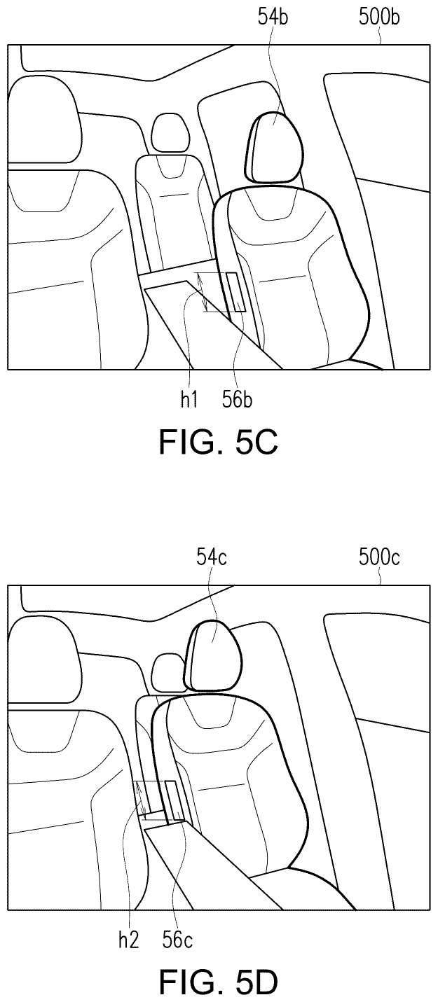

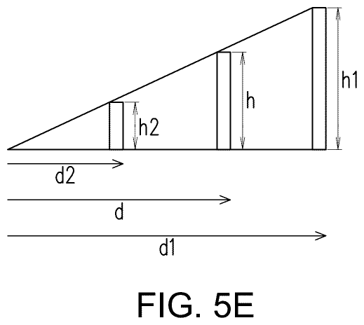

For example, FIG. 5A to FIG. 5E are examples of calculating a vehicle seat position according to an embodiment of the disclosure. Referring to FIG. 5A, in this embodiment, an in-vehicle capturing device 52 is disposed in the vehicle 50 to capture images of the vehicle seat 54 in a nominal position (e.g., front, middle, or rear position). Referring to FIG. 5B to FIG. 5D, images 500a, 500b, and 500c are nominal data images pre-captured by the in-vehicle capturing device 52 with the vehicle seat 54 at the middle, front, and rear nominal positions, respectively.

In this embodiment, a component with a known size is disposed at the design reference position, and the size of the component in the image is obtained and stored in advance as nominal data. The image of the seat design reference position, taking into account variations such as the position of the in-vehicle capturing device 52, is pre-stored in large quantities by the seat manufacturer. By capturing a camera image of the entire vehicle at the seat design reference position and comparing it with the previous data image, changes in the camera position can be eliminated.

Specifically, by preliminarily obtaining and saving the height h of the component 56a on the seat 54a in the image 500a, the height h1 of the component 56b on the seat 54b in the image 500b, and the height h2 of the component 56c on the seat 54c in the image 500c, combined with the distances d, d1, and d2 between the in-vehicle capturing device 52 and the vehicle seat 54 when the vehicle seat 54 is located at the nominal positions of the middle, front, and rear, the relationship between component height and seat distance can be constructed as shown in FIG. 5E. After that, by capturing the actual interior image of the seat and identifying the components on the seat in the image, the actual seat distance can be estimated based on the height of the component, thereby calculating the absolute position of the seat.

In some embodiments, in addition to being affected by forward and rearward movement, the seat position is also affected by the tilt of the seat back. At this time, the absolute position can be determined by storing the angle of the seat back relative to a fixed portion of the vehicle body (e.g., the vehicle pillar). In addition to the angle of the seat back and the angle of the absolute position in the currently captured interior image, the angle of the seat back relative to the fixed portion of the vehicle body is also compared to determine the absolute position relatively.

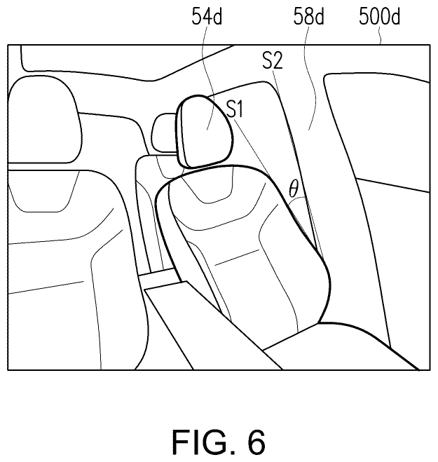

For example, FIG. 6 is an example of calculating a vehicle seat position according to an embodiment of the disclosure. Referring to FIG. 6, this embodiment also uses the in-vehicle capturing device 52 arranged in the vehicle 50 shown in FIG. 5A to capture the vehicle seat 54 to obtain the interior image 500d. By comparing the direction S1 of the seat back 54d with the direction S2 of the vehicle pillar 58 in the interior image 500d, the angle 0 of the seat back 54d relative to the vehicle pillar 58 can be calculated and used to calculate the absolute position of the vehicle seat 54.

In some embodiments, changes in images and position comparison results can be examined, images and data that vary greatly can be removed, and the position can be determined by calculating the average of multiple detection results, thereby improving the accuracy of the detected position.

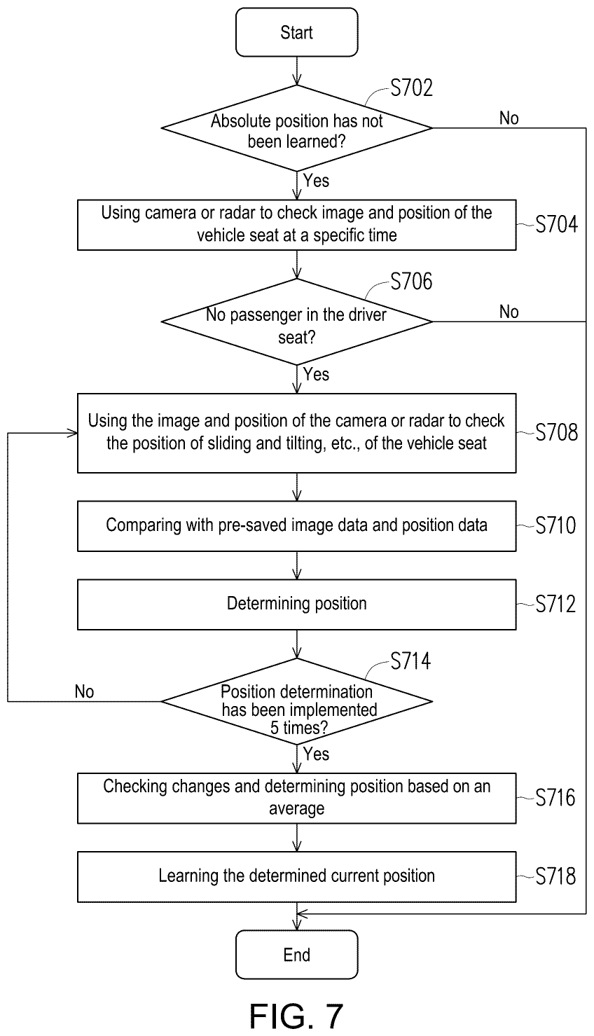

FIG. 7 is a flowchart of a vehicle seat position calculation method according to an embodiment of the disclosure. Referring to FIG. 2 and FIG. 7 at the same time, the vehicle seat position calculation method of this embodiment is applicable to the vehicle seat 20 of FIG. 2. Detailed steps of the vehicle seat position calculation method of this embodiment is described below with reference to each component in the vehicle seat 20.

In step S702, the processing device 25 determines whether the absolute position has not been learned. If it is determined that the absolute position has been learned, the process ends.

If it is determined that the absolute position has not been learned, in step S704, the processing device 25 uses an in-vehicle capturing device 24 such as a camera or radar to check the image and position of the vehicle seat 20 at a specific time. The specific time is, for example, the ignition-off state (IG-OFF), at the time of intelligent keyless locking. When the processing device 25 sends a request to the in-vehicle capturing device 24 such as a camera or radar, the confirmation of the image and position are performed. In addition, the processing device 25 confirms the image and position when the absolute position has not yet been learned.

In step S706, the processing device 25 determines whether there is no passenger in the driver's seat through the image of the vehicle seat 20. If there is a passenger, the process ends.

If there is no passenger in the driver's seat, in step S708, the processing device 25 uses the image and position of the in-vehicle capturing device 24 such as a camera or radar to check the position of sliding and tilting, etc., of the vehicle seat 20. In step S710, the processing device 25 compares the currently obtained image and position with the pre-saved image data and position data, thereby determining the absolute position of the vehicle seat 20 in step S712.

It should be noted that in this embodiment, after each position determination of the vehicle seat 20 is completed, it will be further determined in step S714 whether five position determinations have been implemented so far. The above-mentioned number of determinations is only an example and is not limited to this embodiment. If the position determination has not been performed five times, step S708 is returned to perform the next position determination.

If five position determinations have been implemented, in step S716, the processing device 25 checks the position changes in the five position determinations, and determines the position of the vehicle seat 20 according to the average of the five position determinations. In some embodiments, when determining the position, the processing device 25 removes, for example, images and data that vary greatly, and uses the remaining positions to calculate an average as the position of the vehicle seat 20. Thereby, the accuracy of the detected position can be improved.

Finally, in step S718, the determined current position is learned by the processing device 25. The processing device 25 may, for example, store images and data related to the determined position in an internal storage device, so that it can be used later to determine whether the absolute position has been learned.

To sum up, the vehicle seat according to the embodiment of the disclosure realizes the detection of the absolute position of the seat by using an in-vehicle capturing device, radar, etc., which can address the issue encountered when there is a need to move the seat to the front or rear end for manufacturing and service purposes. Furthermore, it eliminates the need for re-learning trigger conditions and prevents erroneous learning in cases of positional deviation. In addition, the vehicle seat according to the embodiment of the disclosure does not require the addition of limit switches or other position sensors, and maintains the current system configuration of the motor pulse sensor. Therefore, the absolute position of the seat can be detected without increasing costs.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A vehicle seat, the vehicle seat comprising an electric device for moving at least one of a seat cushion and a seat back, comprising:
an in-vehicle capturing device, capturing an interior image including the at least one of the seat cushion and the seat back; and
a processing device, comparing the interior image with an interior specified image when the at least one of the seat cushion and the seat back is in a specified position to calculate an absolute position of the at least one of the seat cushion and the seat back from an amount of change of the at least one of the seat cushion and the seat back relative to the specified position.

2. The vehicle seat according to claim 1, wherein,
the processing device compares the interior image with a vehicle body portion included in the interior specified image.
